(19) United States
(12) Patent Application Publication
(10) Pub. No.: US 2019/0005525 A1
(43) Pub. Date: Jan. 3, 2019

(54) SYSTEM AND METHOD FOR DETERMINING EFFECTIVENESS OF PRODUCT PROMOTIONS

(71) Applicant: Wipro Limited, Bangalore (IN)

(72) Inventors: Paul Gerard Byrne, Clareville (AU); Srinidhi Srinivasan, Bangalore (IN); Saju Ramachandran, Bangalore (IN)

(21) Appl. No.: 15/681,555

(22) Filed: Aug. 21, 2017

(30) Foreign Application Priority Data
Jun. 30, 2017 (IN) 201741023025

(51) Int. Cl. G06Q 30/02

(52) U.S. Cl. CPC G06Q 30/0211; G06Q 30/0213

(57) ABSTRACT

This disclosure relates generally to analyzing product promotions, and more particularly to system and method for determining effectiveness of product promotions. In one embodiment, a method is provided for determining an effectiveness of a promotion. The method includes receiving data related to sales and promotions for a plurality of products. The plurality of products includes a plurality of aggressor products and a plurality of victim products. The method further includes analyzing the data to determine a set of significant aggressor products for each of the plurality of victim products, assessing an impact of each of the set of significant aggressor products on a respective victim product, and determining the effectiveness of the promotion with respect to a product based on the data related to sales of the product under the promotion, and the impact of the product on each of one or more associated victim products.

### CROSS REFERENCE TO RELATED APPLICATION

This disclosure relates to co-pending U.S. patent application Ser. No. 15/087,480 filed on Mar. 31, 2016, which claims priority to Indian Patent Application number 201641008601 filed on Mar. 11, 2016, both entitled “System and Method for Generating Promotion Data”, and both assigned to the same assignee as this application, the entirety of which is hereby incorporated by reference herein.

This application claims the benefit of Indian Patent Application Serial No. 201741023025, filed Jun. 30, 2017, which is hereby incorporated by reference in its entirety.

### FIELD

This disclosure relates generally to product promotions, and more particularly to system and method for determining effectiveness of product promotions.

### BACKGROUND

In an increasingly competitive market, many new and different products available in market, such as products in the consumer packaged goods (CPG) space, vie for consumer attention. To boost sales of their products, companies typically run promotional campaigns. Promotions in a promotional campaign may include distributing sample products, promotional pricing, providing discounts, increasing product visibility by strategic positioning in shops or by running television commercials, and so forth. Typically, these promotional campaigns have a direct relationship with sales of the products. However, many a times, there may be interdependencies and it may therefore be difficult to analyze and to accurately assess effectiveness of promotional campaigns.

For example, promotional campaign by a company to promote sales of one of its products may not only cannibalize the sales of similar products of its competitors, but may also cannibalize the sales of its other similar products. In some scenarios, a product may cannibalize sales of the other products of same brand. It is therefore imperative to understand such interdependencies for determining effectiveness of the promotion.

### SUMMARY

In one embodiment, a method for determining an effectiveness of a promotion is disclosed. In one example, the method includes receiving data related to sales and promotions for a plurality of products from one or more data sources. The plurality of products includes a plurality of aggressor products and a plurality of victim products. The method further includes analyzing the data to determine a set of significant aggressor products for each of the plurality of victim products. The method further includes assessing an impact of each of the set of significant aggressor products on a respective victim product. The method further includes determining the effectiveness of the promotion with respect to a product based on the data related to sales of the product under the promotion, and the impact of the product on each of one or more associated victim products.

In one embodiment, a system for determining an effectiveness of a promotion is disclosed. In one example, the system includes at least one processor and a memory communicatively coupled to the at least one processor. The memory stores processor-executable instructions, which, on execution, cause the processor to receive data related to sales and promotions for a plurality of products from one or more data sources. The plurality of products includes a plurality of aggressor products and a plurality of victim products. The processor-executable instructions, on execution, further cause the processor to analyze the data to determine a set of significant aggressor products for each of the plurality of victim products. The processor-executable instructions, on execution, further cause the processor to assess an impact of each of the set of significant aggressor products on a respective victim product. The processor-executable instructions, on execution, further cause the processor to determine the effectiveness of the promotion with respect to a product based on the data related to sales of the product under the promotion, and the impact of the product on each of one or more associated victim products.

In one embodiment, a non-transitory computer-readable medium storing computer-executable instructions for determining an effectiveness of a promotion is disclosed. In one example, the stored instructions, when executed by a processor, cause the processor to perform operations including receiving data related to sales and promotions for a plurality of products from one or more data sources. The plurality of products includes a plurality of aggressor products and a plurality of victim products. The operations further include analyzing the data to determine a set of significant aggressor products for each of the plurality of victim products. The operations further include assessing an impact of each of the set of significant aggressor products on a respective victim product. The operations further include determining the effectiveness of the promotion with respect to a product based on the data related to sales of the product under the promotion, and the impact of the product on each of one or more associated victim products.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for determining promotion effectiveness in accordance with some embodiments of the present disclosure.

FIG. 2 is a functional block diagram of a promotion effectiveness analytics engine in accordance with some embodiments of the present disclosure.

FIG. 3 is a flow diagram of an exemplary process for determining promotion effectiveness in accordance with some embodiments of the present disclosure.

FIG. 4 is a flow diagram of a detailed exemplary process for determining promotion effectiveness in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

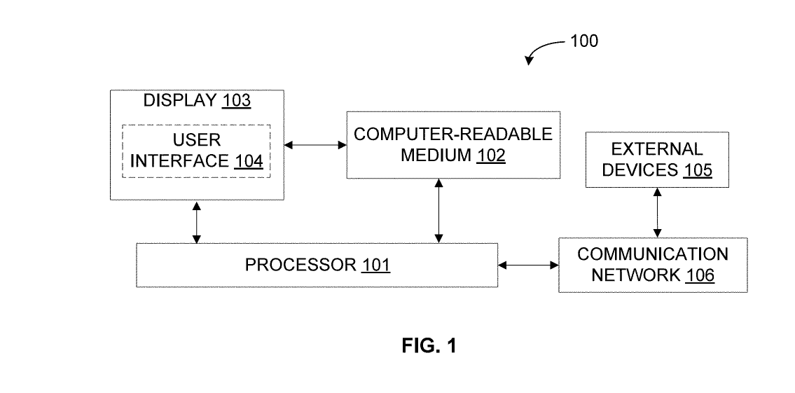

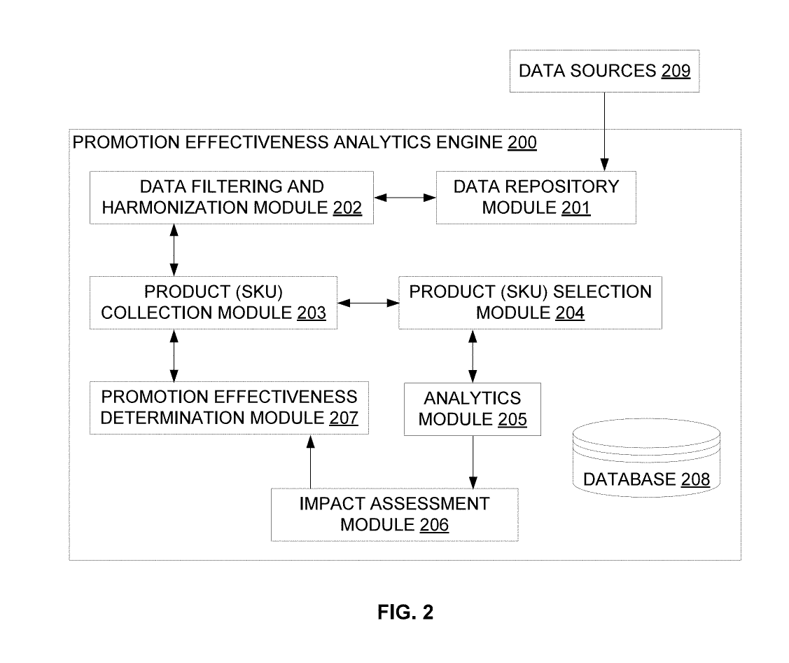

Referring now to FIG. 1, an exemplary system 100 for determining promotion effectiveness is illustrated in accordance with some embodiments of the present disclosure. In particular, the system 100 implements a promotion effectiveness analytics engine to determine effectiveness of product promotions. As will be described in greater detail in conjunction with FIG. 2, the promotion effectiveness analytics engine receives data related to sales and promotions for a plurality of products from one or more data sources. The plurality of products comprises a plurality of aggressor products and a plurality of victim products. The promotion effectiveness analytics engine further analyzes the data to determine a set of significant aggressor products for each of the plurality of victim products, and assesses an impact of each of the set of significant aggressor products on a respective victim product. The promotion effectiveness analytics engine further determines the effectiveness of the promotion with respect to a product based on the data related to sales of the product under the promotion, and the impact of the product on each of one or more associated victim products.

The system 100 includes one or more processors 101, a computer-readable medium (e.g., a memory) 102, and a display 103. The computer-readable medium 102 stores instructions that, when executed by the one or more processors 101, cause the one or more processors 101 to generate named entities in accordance with aspects of the present disclosure. The computer-readable medium 102 may also store various data (e.g., sales revenue, sales volume, promotions, aggressor products, victim products, aggressor-victim combinations, correlation indices, multicollinearity indices, potential aggressors, significant aggressors, impact coefficients, promotion effectiveness, metadata, etc.) that may be received, captured, required, processed, and/or generated by the system 100. The system 100 interacts with a user via a user interface 104 accessible via the display 103. The system 100 may also interact with one or more external devices 105 over a communication network 106 for sending or receiving various data. The external devices 105 may include, but are not limited to, a remote server, a digital device, or another computing system.

Referring now to FIG. 2, a functional block diagram of the promotion effectiveness analytics engine 200 implemented by the system 100 of FIG. 1 is illustrated in accordance with some embodiments of the present disclosure. The promotion effectiveness analytics engine 200 may include various modules that perform various functions so as to determine effectiveness of product promotions. In some embodiments, the promotion effectiveness analytics engine 200 may include a data repository module 201, a data filtering and harmonization module 202, a product (SKU) collection module 203, a product (SKU) selection module 204, an analytics module 205, an impact assessment module 206, and a promotion effectiveness determination module 207. The promotion effectiveness analytics engine 200 may further include a database 208 for storing various data that may be received, captured, required, processed, and/or generated by various module 201-207. It should be noted that each of the products may be identified using a unique product identification code, also referred to as a stock keeping unit (SKU).

The data repository module 201 receives data related to sales and promotions for a number of products from one or more data sources 209. In some embodiments, the data related to sales and promotions may include sales revenue data, sales volume data, merchandising data, promotions, and so forth for each of the products. It should be noted that the data may include data prior to, during, and after promotional campaigns comprising of one or more promotional events and may be used for pre-event analytics as well as for post event analytics. The one or more data sources 209 may include, but are not limited to, a retailer (e.g., authorized retailers, multi-brand retailers, departmental store, supermarket, hypermarket, etc.), a supplier (e.g., a distributer, a manufacturer, etc.), a sales team (e.g., in-house sales team, distributers, channel partners, etc.), a third-party market research organization (e.g., A C NIELSEN, IRI, RSI, etc.), a real-time sales management platform (e.g., RETAIL LINK, etc.). Thus, in some embodiments, the data repository module 201 may be adapted to incorporate syndicated data as well as retailer direct point of sale (PoS) data from data sources 209 such as A C NIELSEN, IRI, RETAIL LINK, RSI, and so forth. The data received by the data repository module 201 may be stored in the database 208.

The products may include aggressor products as well as victim products. As will be appreciated, a product of a company that cannibalizes the sales of other similar products of the company, apart from similar products of one or more competitor of the company, is typically referred to as an aggressor product. The similar products whose sale is cannibalized by the aggressor product are typically referred to as victim products. Thus, an aggressor is that product or SKU which cannibalizes the sales, while a victim is that product or SKU whose sales get cannibalized (e.g., due to a promotion offered on the aggressor). In some embodiments, the aggressor products and the victim products are pre-identified by one or more data sources 209. Alternatively, in some embodiments, the aggressor products and the victim products are identified or fed by a user through a user interface. Thus, the user may identify or feed categories, sub-categories, product hierarchy for the products of the company as well similar products of the competitors. For example, the data may be collected from one or more consumer packaged goods (CPG) clients for all products, and stored in the data repository module 201. An expert user may then select all the victim-aggressor combinations from the collected data via the user interface.

The data received by the data repository module 201 may be in structured format or in unstructured format. The structured data may be in a standard format. However, the unstructured data may be in a format different from the standard format or may not be formatted at all. In an example, unstructured data may include e-mail messages, word processing documents, images, presentations, webpages, etc. The data filtering and harmonization module 202 acquires the structured and the unstructured data from the data repository module 201, and performs various data processing operations to filter and harmonize the data into a pre-defined format capable of being processed by subsequent modules 203-207. The pre-defined format may have robust capabilities to capture and display various sales and promotion related data points. In some embodiments, the data filtering and harmonization module 202 may perform harmonization using a master template, and incorporating both the structured and unstructured data in the master template format. Additionally, the data filtering and harmonization module 202 may perform various data processing operations to cleanse the data to ensure that the data is complete (e.g., no missing records) and ready for subsequent processing. The data filtering and harmonization module 202 then provides the cleansed and harmonized data to the product (SKU) collection module 203. In some embodiments, the data filtering and harmonization module 202 may filter or prepare a single data set from all the victim-aggressor combinations' data for analysis.

The product (SKU) collection module 203 acquires all victim-aggressor combinations' data from the data filtering and harmonization module 202, thereby creating a harmonized superset data for analysis. The product (SKU) collection module 203 then provides all victim-aggressor combinations' data to the product (SKU) selection module 204 for further analysis. The product (SKU) selection module 204 analyzes all victim-aggressor combinations' data to determine potential aggressor products for each of the victim products. In some embodiments, the product (SKU) selection module 204 performs analysis by screening the data to determine the potential aggressor products for each of the victim products from among all aggressor products. In some embodiments, the product (SKU) selection module 204 screens the data by deriving a correlation index between each of the aggressor products and each of the victim products, and then selects the potential aggressor products based on the corresponding correlation indices. It should be noted that, in some embodiments, the correlation may be determined using collinearity or multicollinearity. In particular, multicollinearity may be employed as there may be multiple independent variables in the victim-aggressor combinations' data. Thus, in such embodiments, the selection of the potential aggressor products for a given victim product may be based on the multicollinearity indices between the aggressor products and the given victim product. For example, the product (SKU) selection module 204 may select those aggressor products as potential aggressor products that have multicollinearity indices greater than a pre-defined threshold value (e.g., greater than 0.6), or that meet a pre-defined condition based on their multicollinearity indices (e.g., in top 20% or in top 40). Thus, the product (SKU) selection module 204 filters potential aggressors for every victim-aggressor combination. The potential aggressors may then be provided to the analytics module 205.

The analytics module 205 receives potential aggressors for each victim from the product (SKU) selection module 204. The analytics module 205 then determines significant aggressors for a given victim from among the potential aggressors for the given victim. In some embodiments, the analytics module 205 determines significant aggressors from among the plurality of potential aggressors using back-step filtering multivariate regression algorithm. Further, the analytics module 205 provides the significant aggressors for a victim product to the user through the user interface. Additionally, in some embodiments, the analytics module 205 may estimate impact coefficients for each of the significant aggressors on a respective victim using the back-step filtering multivariate regression algorithm. The analytics module 205 may then provide the impact coefficients to the impact assessment module 206.

The impact assessment module 206 assesses an impact of each of the significant aggressor products on a respective victim product. In some embodiments, the impact assessment module 206 may estimate the impact of significant aggressors on a victim based on the impact coefficients. In some embodiments, the impact coefficients may be cannibalization coefficients, and the impact assessment module 206 estimates cannibalization impact of significant aggressors on a victim based on the cannibalization coefficients. The impact assessment module 206 may then provide the impact of significant aggressors on a victim to the promotion effectiveness determination module 207.

The promotion effectiveness determination module 207 receives the impact of significant aggressors on a victim from the impact assessment module 206. The promotion effectiveness determination module 207 also receives data related to sales of the product under the promotion from the product (SKU) collection module 203. The promotion effectiveness determination module 207 then determines effectiveness of the promotion with respect to a product based on the data related to sales of the product under the promotion, and the impact of the product on each of one or more associated victim products. As will be appreciated, it is imperative to understand the significant victims for an aggressor on a promotion, and quantify the sales loss for associated victims, which then needs to be incorporated for determining effectiveness of the promotion. It should be noted that the promotion effectiveness analytics engine 200 starts with victims as the input parameter (i.e., identifying significant aggressors for each of the victims, and assessing impact of each of the significant aggressors), but then the output is translated for the aggressor (i.e., determining effectiveness of the promotion for an aggressor based on its impact on victims).

As will be appreciated, most of the companies have requirement to understand the outcome of trade promotions in terms of cannibalization with regard to their products and also products from competitors. The output of the impact assessment module 206 and the promotion effectiveness determination module 207 may therefore help the companies design promotions for their products by providing clear business intelligence of aggressors' behavior and helps in revenue enhancement or financial reconciliation. For example, significant aggressors are highlighted against a selected victim which helps the client with precise business intelligence to design plan and design product promotions in the future. In some embodiments, the model definitions and model coefficients generated by the modules 203-207 may be converted as metadata, and stored in the database 208 for every victim-aggressor relationship. The metadata generated and stored may be then used for future reference. The saved model is particularly useful with respect to dynamic changes in victim-aggressor relationships.

It should be noted that the promotion effectiveness analytics engine 200 may be implemented in programmable hardware devices such as programmable gate arrays, programmable array logic, programmable logic devices, and so forth. Alternatively, the promotion effectiveness analytics engine 200 may be implemented in software for execution by various types of processors. An identified engine of executable code may, for instance, include one or more physical or logical blocks of computer instructions which may, for instance, be organized as an object, procedure, function, module, or other construct. Nevertheless, the executables of an identified engine need not be physically located together, but may include disparate instructions stored in different locations which, when joined logically together, include the engine and achieve the stated purpose of the engine. Indeed, an engine of executable code could be a single instruction, or many instructions, and may even be distributed over several different code segments, among different applications, and across several memory devices.

As will be appreciated by one skilled in the art, a variety of processes may be employed for determining effectiveness of product promotions. For example, the exemplary system 100 and the associated promotion effectiveness analytics engine 200 may determine an effectiveness of a product promotion by the processes discussed herein. In particular, as will be appreciated by those of ordinary skill in the art, control logic and/or automated routines for performing the techniques and steps described herein may be implemented by the system 100 and the associated promotion effectiveness analytics engine 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

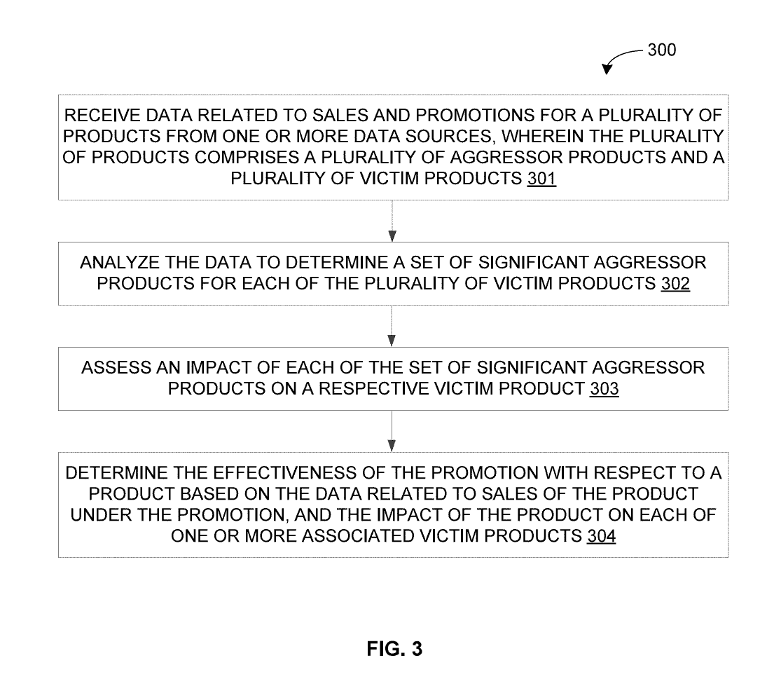

For example, referring now to FIG. 3, exemplary control logic 300 for determining an effectiveness of a promotion via a system, such as system 100, is depicted via a flowchart in accordance with some embodiments of the present disclosure. As illustrated in the flowchart, the control logic 300 includes the step of receiving data related to sales and promotions for a plurality of products from one or more data sources at step 301. It should be noted that the plurality of products includes a plurality of aggressor products and a plurality of victim products. The control logic 300 further includes the steps of analyzing the data to determine a set of significant aggressor products for each of the plurality of victim products at step 302, and assessing an impact of each of the set of significant aggressor products on a respective victim product at step 303. The control logic 300 further includes the step of determining the effectiveness of the promotion with respect to a product based on the data related to sales of the product under the promotion, and the impact of the product on each of one or more associated victim products at step 304.

In some embodiments, the data related to sales and promotions comprises at least one of sales revenue data, sales volume data, and merchandising data prior to, during, and after one or more promotional events for each of the plurality of products. Additionally, in some embodiments, the one or more data sources comprises at least one of: a retailer, a supplier, a sales team, a third-party market research organization, a real-time sales management platform. Further, in some embodiments, the plurality of aggressor products and the plurality of victim products are identified or fed by a user.

In some embodiments, analyzing the data to determine the set of significant aggressor products at step 302 includes screening the data to determine a plurality of potential aggressor products for each of the plurality of victim products, and determining the set of significant aggressor products from among the plurality of potential aggressor products. Additionally, in some embodiments, screening the data includes deriving a multicollinearity index between each of the plurality of aggressor products and each of the plurality of victim products, and selecting the plurality of potential aggressor products from among the plurality of aggressor products based on the corresponding multicollinearity indices. Further, in some embodiments, determining the set of significant aggressor products includes determining the set of significant aggressor products from among the plurality of potential aggressor products using back-step filtering multivariate regression.

In some embodiments, assessing the impact at step 303 includes estimating impact coefficients using back-step filtering multivariate regression. Additionally, in some embodiments, the control logic 300 includes the steps of converting the impact of each of the set of significant aggressor products on a respective victim product as metadata, and storing the metadata for subsequent use.

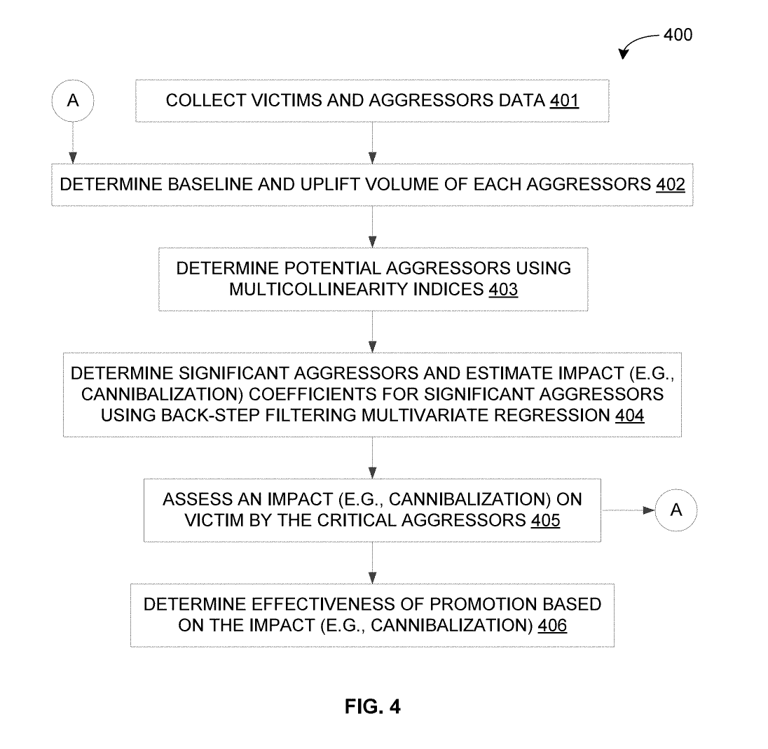

Referring now to FIG. 4, exemplary control logic 400 for determining effectiveness of product promotions is depicted in greater detail via a flowchart in accordance with some embodiments of the present disclosure. As illustrated in the flowchart, the control logic 400 includes the steps of collecting victims and aggressors data at step 401, determining a baseline and an uplift volume of each aggressors at step 402, determining potential aggressors using multicollinearity indices at step 403, determining significant aggressors and estimating impact (e.g., cannibalization) coefficients for the significant aggressors using back-step filtering multivariate regression at step 404, assessing an impact (e.g., cannibalization) on victim by the significant aggressors at step 405, and determining effectiveness of promotion based on the impact (e.g., cannibalization) at step 406. Each of these steps will be described in greater detail below.

At step 401, the data repository module 201 collects the data from user (e.g., CPG clients) and/or data sources 209 on a periodic (e.g., weekly, monthly, etc.) basis. The data may broadlly be historical time series data on the promotion and non promotion performance of the aggressors and the victims respectively. This paves way for defining the victim-aggressor relationship. Upon data collection, the data filtering and harmonization module 202 subjects the data to harmonization. The harmonized data may then be imported for screening and cleansing. Any missing aggressor values may be initialized to zero.

At step 402, the product (SKU) selection module 204 determines a baseline volume and an uplift volume (i.e., increase in the volume sales over the baseline volume while on promotion) of each aggressors using a set of quantitative methodologies. The process is repeated continuously for all victim-aggressor combinations. It should be noted that a product or SKU that is a victim may be an aggressor while on promotion for another product or SKU. Some of the quantitative methodologies for calculating baseline and uplift volume may be found in co-pending Indian Patent Application No. 201641008601 filed on Mar. 11, 2016 and co-pending U.S. patent application Ser. No. 15/087,480 filed on Mar. 31, 2016, both entitled “System and Method for Generating Promotion Data”, and both assigned to the same assignee as this application, the entirety of which is hereby incorporated by reference herein.

At step 403, upon calculation of the the baseline and uplift volume for all the victim-aggressor combinations, the product (SKU) selection module 204 identifies potential aggressors for each of the victim-aggressor combinations using multi-step regression technique. The first part of the multi-step regression technique derives a multicollinearity index between each of the aggressor products and each of the victim products. The potential aggressors are then identified and selected from the superset of aggressors based on their multicollinearity indices. For example, if there are 200 data points in the dataset, the process filters no more than the top 20% of 200 (i.e., 40 datapoints) as potential aggressors by deriving the multicollinearity indices. In some embodiments, the process may also rank the filtered potential aggressors based on their multicollinearity indices.

As will be appreciated, the multicollinearity indices signify the extent of the relationship between aggressors and the associated victims. The multicollinearity index may be in the range of −1 and +1. The higher the absolute value of the multicollinearity index (e.g., 0.85), the higher correlation the aggressor has with the victim; hence such aggressor may have higher impact on the victim and may therefore be identified as a potential aggressor. On the other hand, the lower the absolute value of the multicollinearity index (e.g., 0.15), the lower correlation the aggressor has with the victim; hence such aggressor may have limited or no impact on the victim and may therefore not be identified as a potential aggressor. The selection of potential aggressors ensures quantitative stability so that the model does not crash if all the victim-aggressor combinations are subjected to analysis. In other words, if the number of aggressors are substantially higher as compared to the number of data points available for analysis, there exists a high possibility that the model may be overfitted or unduly sensitive to changes in the aggressors.

At step 404, the analytics module 205 determines significant aggressors from among the potential aggressors, and estimates impact (e.g., cannibalization) coefficients for significant aggressors using back-step filtering multivariate regression algorithm. The set of potential aggressors identified at step 403 are subjected to an automated back-step filtering multivariate regression algorithm that filters potential aggressors based on multiple statistical criteria such as the Akaike information criterion (AIC) and the p,t values. The algorithm iteratively works in the backward direction under the assumption that all the potential aggressors are significant, until the most significant are retained and less significant are filtered. This results in identifying the significant aggressors and their impact (e.g., cannibalization) coefficients, and therefore enables estimating the extent of impact (e.g., cannibalization) of sales of a victim. By way of an example, the functional form of the model for determining significant aggressors and their impact coefficients may be represented by a set of equations provided below:

$$\begin{matrix}Victim Scan Volume ( Y ) = \\ α + Uplift Volume of {Aggressors ( β )}_{1 ... N} ( {X}_{1 ... N} ) + ɛ … \\ Fit 1 that includes all potential aggressors \\ ⋮⋮ \\ ⋮⋮ \\ Victim Scan Volume ( Y ) = α + {β}_{1} {X}_{1} + {β}_{4} {X}_{4} + … + {β}_{N - 1} {X}_{N - 1} + ɛ … \\ Fit 2 that filters non \text{-} significant aggressors\end{matrix}$$

At the first step of back-filtering of aggressors, all the potential aggressors may be assigned equal importance. The model may then test the deletion of every single variable in a way that such deletion does not significantly affect the model fit or robustness. As per a pre-specified confidence interval estimates (e.g., 90%, 95%, etc.), the model may work in the backward direction until it finds the significant aggressors which may be estimated at the pre-specified confidence levels. It may be possible that there may be four aggressors that are significant (e.g., significant cannibalization candidates) for a victim, whereas there may be eight or more aggressors that may be significant for another victim. The model accuracy may be measured by the mutiple R squared value of the step regression, and the mean absolute percentage error (MAPE) which may be calculated as the percentage difference between the actual and predicted values.

At step 405, the impact assessment module 206 assesses the impact (e.g., cannibalization impact) on a victim by the associated significant aggressors. The impact coefficients (e.g., cannibalization coefficients) derived at step 404 represent both the individual and collective impact on the victim. The summation of the filtered aggressor impact coefficients in conjunction with the respective aggressor uplift volumes determines the extent of impact on the victim by the significant aggressors. By way of an example, the impact on the victim (i.e., change in the victim volume caused by the aggressors) and the total victim volume after the impact may be represented by equations provided below:

Impact_{victim}=Σ_{(β-imp Coeff}_{ₛᵤₘ})×Uplift_{Aggressor}_{ₛᵤₘ}

TotalVolume_{victim}=α(regression intercept)+Σ_{(β-imp Coeff}_{ₛᵤₘ})×Uplift_{Agressor}_{ₛᵤₘ}+ϵ(error term)

The beta (β) value represents the impact coefficient of that respective aggressors with the victim. The value may be either positive or negative. If the (β) value is negative, it means that any promotion given on that respective aggressor negatively impacts (i.e., cannibalizes) the sales of the victim. For example, if (β=−0.6), it indicates if there is an uplift of the aggressor's volume by 1 unit, the victim's sales get cannibalized by 0.6 units. However, if the (β) value is positive, it means that any promotion given on that respective aggressor positively impacts (i.e., promotes) the sales of the victim. For example, if (β=0.85), it indicates that when the aggressor is promoted, the victim's sales are not cannibalized but increase by 0.85 units with every unit increase of the aggressor.

It should be noted that the steps 402-405 may be repeated for interchangeable victim-aggressor combinations. At step 406, the promotion effectiveness determination module 207 determines effectiveness of the promotion based on the impact. The process therefore determines effective promotional campaigns for the client based on the impact assessment. As will be appreciated, the many-many victim-aggressor mapping by promotion effectiveness determination module 207 provides the client a robust platform for advanced promotion designing and planning. For example, the client may experiment with variation in timing of promotional campaigns (e.g., summer promotions rather than spring promotions in the Australian and European markets, Christmas promotions rather than Thanksgiving day promotions in the US market, etc.). By way of example, if the cannibalizaton coefficient of an aggressor is negative, the client would have better business intelligence to avoid promotion during spring but instead tag the aggressor for promotion during summer. Similarly, by way of example, for the US market, if the cannibalization coefficient is positive, this would help in the client in deciding promotions during Christmas. Further, as will be appreciated, such intelligence for promotion designing and planning may result in reduction in expenditure on less impactful promotional campaigns and advertisements, and boost revenue by choosing the right time and the right place of promotions as per market information.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

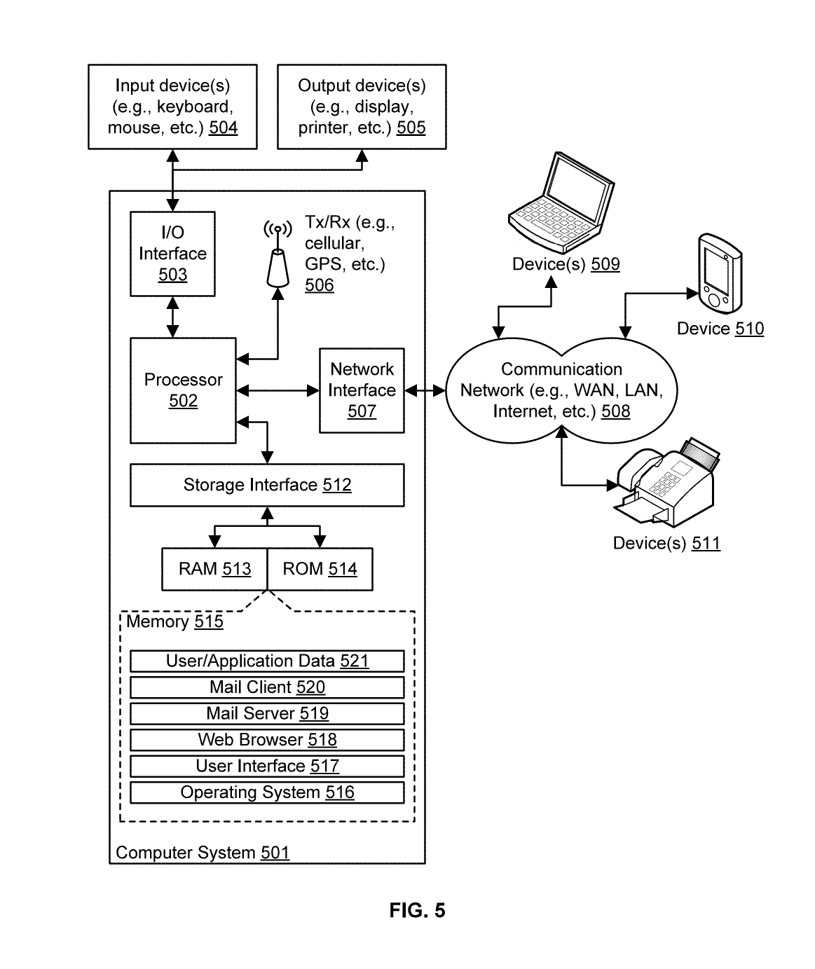

The disclosed methods and systems may be implemented on a conventional or a general-purpose computer system, such as a personal computer (PC) or server computer. Referring now to FIG. 5, a block diagram of an exemplary computer system 501 for implementing embodiments consistent with the present disclosure is illustrated. Variations of computer system 501 may be used for implementing system 100 and promotion effectiveness analytics engine 200 for determining effectiveness of product promotions. Computer system 501 may include a central processing unit (“CPU” or “processor”) 502. Processor 502 may include at least one data processor for executing program components for executing user-generated or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.), collectively referred to as memory 515, via a storage interface 512. The storage interface 512 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 515 may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., sales revenue, sales volume, promotions, aggressor products, victim products, aggressor-victim combinations, correlation indices, multicollinearity indices, potential aggressors, significant aggressors, impact coefficients, promotion effectiveness, metadata, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, NoSQL, etc.). Such databases may be consolidated or distributed, sometimes among the various computer systems discussed above in this disclosure. It is to be understood that the structure and operation of any computer or database component may be combined, consolidated, or distributed in any working combination.

As will be appreciated by those skilled in the art, the techniques described in the various embodiments discussed above provide for quantitative assessment of impact of aggressors on a victim. The techniques described in the embodiments discussed above model multiple aggressors and identify significant subsets with minimal manual intervention. The techniques described above then predict impact of each of the significant aggressors on a victim with a high degree of accuracy. The techniques therefore enable the companies to pick and choose or play with their promotional campaigns with caution, and avoid mistakes of overdoing with their promotions for the absence of reliable market information.

For example, the techniques described in the various embodiments discussed above help the clients by identifying victim products (their own products as well as that of competitors) for a product on promotion. Additionally, the techniques help in understanding and quantifying the impact of a particular aggressor product under promotion on various victim products. Further, the techniques help in evaluating effectiveness of a completed promotion based on the impact (i.e., own as well as cross-category cannibalization), thereby enabling a more realistic assessment of return on investment (ROI). Moreover, the techniques help in understanding the impact of competitor promotions on own product (i.e., competitor product modeled as aggressor, and own products as victims). In other words, the techniques described in the embodiments discussed above help in identifying and evaluating the impact of deep promotions on the competitor product, quantifying the steal from competitor products, as well as in identifying, evaluating, and quantifying the impact of competitor promotions on own products. The techniques therefore enable designing and planning of future promotions using the impact coefficients and assessment. A demand planner may use the impact coefficients derived at the product level for planning future promotion by removing the negative promotion (i.e., yielding negative or limited ROI) and focusing only on the positive promotions (i.e., yielding good ROI).

The specification has described system and method for determining effectiveness of product promotions. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining an effectiveness of a promotion, the method comprising:
receiving, by a promotion effectiveness analytics engine, data related to sales and promotions for a plurality of products from one or more data sources, wherein the plurality of products comprises a plurality of aggressor products and a plurality of victim products;
analyzing, by the promotion effectiveness analytics engine, the data to determine a set of significant aggressor products for each of the plurality of victim products;
assessing, by the promotion effectiveness analytics engine, an impact of each of the set of significant aggressor products on a respective victim product;
determining, by the promotion effectiveness analytics engine, the effectiveness of the promotion with respect to a product based on the data related to sales of the product under the promotion, and the impact of the product on each of one or more associated victim products.

2. The method of claim 1, wherein the data related to sales and promotions comprises at least one of: sales revenue data, sales volume data, or merchandising data prior to, during, and after one or more promotional events for each of the plurality of products.

3. The method of claim 1, wherein the one or more data sources comprises at least one of: a retailer; a supplier; a sales team; a third-party market research organization; or a real-time sales management platform.

4. The method of claim 1, wherein the plurality of aggressor products and the plurality of victim products are identified or fed by a user.

5. The method of claim 1, wherein the analyzing the data to determine the set of significant aggressor products comprises:
screening the data to determine a plurality of potential aggressor products for each of the plurality of victim products; and
determining the set of significant aggressor products from among the plurality of potential aggressor products.

6. The method of claim 5, wherein the screening the data comprises:
deriving a multicollinearity index between each of the plurality of aggressor products and each of the plurality of victim products; and
selecting the plurality of potential aggressor products from among the plurality of aggressor products based on the corresponding multicollinearity indices.

7. The method of claim 5, wherein the determining the set of significant aggressor products comprises determining the set of significant aggressor products from among the plurality of potential aggressor products using back-step filtering multivariate regression.

8. The method of claim 1, wherein the assessing the impact comprises estimating impact coefficients using back-step filtering multivariate regression.

9. The method of claim 1, further comprising converting the impact of each of the set of significant aggressor products on a respective victim product as metadata, and storing the metadata for subsequent use.

10. A system for determining an effectiveness of a promotion, the system comprising:
at least one processor; and
a computer-readable medium storing instructions that, when executed by the at least one processor, cause the at least one processor to perform operations comprising:
receiving data related to sales and promotions for a plurality of products from one or more data sources, wherein the plurality of products comprises a plurality of aggressor products and a plurality of victim products;
analyzing the data to determine a set of significant aggressor products for each of the plurality of victim products;
assessing an impact of each of the set of significant aggressor products on a respective victim product; and
determining the effectiveness of the promotion with respect to a product based on the data related to sales of the product under the promotion, and the impact of the product on each of one or more associated victim products.

11. The system of claim 10, wherein the analyzing the data to determine the set of significant aggressor products comprises:
screening the data to determine a plurality of potential aggressor products for each of the plurality of victim products; and
determining the set of significant aggressor products from among the plurality of potential aggressor products.

12. The system of claim 11, wherein the screening the data comprises:
deriving a multicollinearity index between each of the plurality of aggressor products and each of the plurality of victim products;
selecting the plurality of potential aggressor products from among the plurality of aggressor products based on the corresponding multicollinearity indices.

13. The system of claim 11, wherein the determining the set of significant aggressor products comprises determining the set of significant aggressor products from among the plurality of potential aggressor products using back-step filtering multivariate regression.

14. The system of claim 10, wherein the assessing the impact comprises estimating impact coefficients using back-step filtering multivariate regression.

15. The system of claim 10, wherein the operations further comprise converting the impact of each of the set of significant aggressor products on a respective victim product as metadata, and storing the metadata for subsequent use.

16. A non-transitory computer-readable medium storing computer-executable instructions for:
receiving data related to sales and promotions for a plurality of products from one or more data sources, wherein the plurality of products comprises a plurality of aggressor products and a plurality of victim products;
analyzing the data to determine a set of significant aggressor products for each of the plurality of victim products;
assessing an impact of each of the set of significant aggressor products on a respective victim product; and
determining the effectiveness of the promotion with respect to a product based on the data related to sales of the product under the promotion, and the impact of the product on each of one or more associated victim products.

17. The non-transitory computer-readable medium of claim 16, wherein the analyzing the data to determine the set of significant aggressor products comprises:
screening the data to determine a plurality of potential aggressor products for each of the plurality of victim products; and
determining the set of significant aggressor products from among the plurality of potential aggressor products.

18. The non-transitory computer-readable medium of claim 17, wherein the screening the data comprises:
deriving a multicollinearity index between each of the plurality of aggressor products and each of the plurality of victim products; and
selecting the plurality of potential aggressor products from among the plurality of aggressor products based on the corresponding multicollinearity indices.

19. The non-transitory computer-readable medium of claim 17, wherein the determining the set of significant aggressor products comprises determining the set of significant aggressor products from among the plurality of potential aggressor products using back-step filtering multivariate regression.

20. The non-transitory computer-readable medium of claim 16, wherein the assessing the impact comprises estimating impact coefficients using back-step filtering multivariate regression.
